(19) United States
(12) Patent Application Publication
(10) Pub. No.: US 2005/0161170 A1
(43) Pub. Date: Jul. 28, 2005

(54) Door drive housing

(75) Inventor: Michael Hormann, Oerlinghausen (DE)

Correspondence Address: DILWORTH & BARRESE, LLP, 333 EARLE OVINGTON BLVD., UNIONDALE, NY, 11553, US

(73) Assignee: Marantec Antriebs-und Steuerungstechik GmbH & Co. KG.

(21) Appl. No.: 11/007,020

(22) Filed: Dec. 8, 2004

(30) Foreign Application Priority Data
Dec. 8, 2003 (DE) 203 18 994.9

(51) Int. Cl. E06B 3/92

(52) U.S. Cl. 160/138

(57) ABSTRACT

The present invention pertains to a door drive housing with an assembly holding device for mounting an electric door drive assembly with at least one electric terminal, particularly of a transformer, wherein the assembly holding device contains preferably separable mounting means for mounting the assembly. According to the invention, the door drive housing is characterized in that the mounting means contain a plug-type receptacle, into which the assembly can be inserted, as well as snap-in means that positively interlock with the assembly during the insertion into the plug-type receptacle.

The present invention pertains to a door drive housing with an assembly holding device for mounting an electric door drive assembly with at least one electric terminal, particularly of a transformer, wherein the assembly holding device contains preferably separable mounting means for mounting the assembly.

Door drives such as, for example, the drives of garage door openers are usually arranged in a housing that, in case of a garage door opener, is mounted on the ceiling within the garage. A drive motor and a gear that drives a sled via a chain or a belt are usually accommodated in the housing, wherein the sled travels along a rail that is connected to the housing. The sled is connected to the garage door such that the latter can be opened and closed.

In door drives of this type, it would be desirable to utilize the door drive housing for different door drives or for door drives equipped with different or additional drive components. Until now, different housings were normally utilized for differently configured door drives in order to preserve the advantage achieved with this measure, namely the respective utilization of a housing with small structural dimensions. However, this is associated with high costs because a separate housing needs to be manufactured and held in storage for each type of drive.

The accommodation of electrical assemblies of the door drive in the housing is subject to special requirements because the electric terminals of the respective assembly need to be easily accessible. In addition, some electrical assemblies have a considerable weight such that a secure mounting is absolutely imperative. Relatively heavy power transformers are regularly utilized in drives for garage door openers, wherein these power transformers not only supply the electronics with an extra-low voltage, but also generate the motor voltage. These transformers need to be securely held in the device. In addition, a series of electric connections needs to be produced on the primary and the secondary side. It should be possible to easily install the transformers despite the required secure mounting and the accessible arrangement of the electric terminals. In addition, it would be desirable to achieve a simple subsequent installation or exchange of different transformers with different power ratings and supply voltage variations.

Consequently, the present invention is based on the objective of developing an improved door drive housing of the described typed which eliminates the disadvantages of the state of the art and represents an advantageous additional development thereof. The invention aims, in particular, to achieve a stable and simple mounting of electric door drive assemblies, for example, transformers, while simultaneously allowing a simple installation of the electric terminals.

According to the invention, this objective is attained with a door drive housing according to claim 1. Preferred variations of the invention form the objects of the dependent claims.

According to the invention, the door drive housing is characterized in that the mounting means for the electric door drive assembly comprise a plug-type receptacle, into which the assembly can be inserted, as well as snap-in means that positively interlock with the assembly during the insertion into the plug-type receptacle. The plug-type receptacle is realized in such a way that the position of the assembly is, in principle, already predetermined and fixed by the plug-type receptacle. The snap-in means prevent the assembly from sliding out of the plug-type receptacle and secures the assembly in the inserted position. The plug-type receptacle causes the assembly to be inserted in a predetermined position referred to the snap-in means such that it can engage with the assembly in a precisely fitted fashion. This significantly simplifies the installation process. The mounting of the transformer can be realized without any tools, wherein the electric terminals of the assembly preferably are automatically installed simultaneously with the insertion into the plug-type receptacle.

At least one through-opening may be provided in the bottom of the plug-type receptacle in order to accommodate at least one electric terminal of the assembly, wherein said through-opening forms a plug connector receptacle for a plug to be connected to the terminal of the assembly. The electric terminals of the assembly, particularly of the transformer, are automatically threaded into the corresponding through-openings in the bottom of the plug-type receptacle during the insertion into the plug-type receptacle of the assembly holding device, namely such that the terminals protrude through the through-opening and are seated in the plug connector receptacle. The plug-type receptacle of the assembly holding device preferably is realized in a pot-shaped or trough-shaped fashion, wherein the side walls contain or form guide surfaces in order to guide the electrical assembly with sufficient precision for threading the electric terminals into the plug connector receptacles without causing damages.

According to an additional development of the invention, the plug connector receptacles for the electric terminals may respectively form a chimney-shaped projection that is integrally formed onto the bottom of the plug-type receptacle and annularly surrounds the respective electric terminal of the inserted assembly.

In this case, it is particularly advantageous that the plug connector receptacle has an inside contour that contains clamping and/or interlocking surfaces such that the plugs to be pushed onto the terminals of the electric assembly are held in a clamped or interlocked fashion in the plug connector receptacles in the bottom of the assembly holding device and consequently can be pre-installed accordingly. In this case, the corresponding connecting cables are inserted into the through-openings or plug connector receptacles provided in the bottom with their plug connectors from the side situated opposite of the plug-type receptacle, namely such that they are held therein in a clamped or interlocked fashion. The assembly holding device can then be pre-installed. When an electrical assembly is subsequently inserted into the plug-type receptacle, the electric terminals are threaded into the plug connector receptacles in the bottom of the assembly holding device and come in contact with the pre-installed plug connectors.

In order to securely hold the electrical assembly in the plug-type receptacle, the interlocking means may comprise two elastic, flange-shaped snap-in tabs that preferably extend essentially parallel to the inserting direction defined by the plug-type receptacle and, when inserting the assembly, initially slide over the plug-type receptacle such that the snap-in tabs are laterally bent away in a springable fashion. Once the assembly reaches the intended installation position, the snap-in tabs spring back and interlock with the assembly. It goes without saying that it is not absolutely imperative to provide exactly two snap-in tabs. At least one such snap-in tab is provided in order to interlock the assembly in the installation position. If so required, more than two snap-in tabs may be provided in order to securely mount the electrical assembly, for example, in complicated applications in which significant vibrations occur. In the advantageous additional development of the invention, two snap-in tabs are provided and preferably arranged opposite of one another.

It is advantageous that the snap-in tabs may be integrally formed onto the plug-type receptacle such that they respectively form an extension of opposite plug-type receptacle walls, namely in the form of a projection. These projections are provided with snap-in hooks that are able to interlock with the assembly to be inserted on their free protruding end. If so required, the assembly can subsequently also be detached by laterally bending away the projecting snap-in tabs in this embodiment of the interlocking means. This causes the snap-in projections to disengage such that the assembly can be pulled out.

According to an additional development of the invention, the assembly holding device for the transformer is not rigidly or inseparably connected to the device body of the door drive housing, but rather subsequently mounted thereon with the aid of non-positive and/or positive connecting means. This makes it possible to individually assemble the door drive housing in accordance with the respective requirements. The modular design of the door drive housing makes it possible to individually configure and suitably assemble the door drive housing from several housing parts or assembly carriers.

In this case, it is preferred that the size of the entire device body can also be varied.

It is possible, in particular, to expand the housing in order to accommodate additional or larger drive components, wherein said expansion can be separably connected to the carrier base body in a precisely fitted fashion. This means that the door drive housing has a modular design and consists of several housing modules, from which the housing can be assembled in accordance with the respective drive components to be inserted. The housing, in particular, can be variably assembled in different sizes, wherein the same carrier base body is used in all instances such that the number of parts to be held in storage can be significantly reduced. If no housing expansion is required, the housing is exclusively formed by the carrier base body and, if applicable, the cover attached thereon. The housing can be expanded if the basic configuration of the housing does not provide sufficient space for accommodating additional drive components.

According to an additional development of the invention, the housing expansion consists of a carrier body expansion that can be separably connected to the carrier base body and an additional cover that can be connected to at least the carrier body expansion. The housing expansion may be provided with a cover that only covers the carrier body expansion and, in this respect, supplements the cover provided on the carrier base body. In this case, it is preferred that the additional cover of the housing expansion adjoins the cover provided on the carrier base body in a precisely fitted fashion.

In an alternative additional development of the invention, the cover of the housing expansion replaces the cover on the carrier base body. In this case, the cover of the housing expansion extends over the carrier base body as well as the carrier body expansion connected thereto and limits a common housing interior. When expanding the carrier base body with a housing expansion, a new cover is attached that covers the entire expanded carrier body in this case.

The carrier body expansion preferably has an edge contour that seamlessly adjoins the outer edge contour of the carrier base body. In this case, the carrier body expansion preferably is shaped in such a way that it forms an expanded carrier shell, into which the desired drive components can be inserted, together with the carrier base body. The edge of the carrier shell formed by the carrier base body and the carrier body expansion may contain a peripheral web, onto which the appropriate cover can be attached.

The carrier body expansion may, in principle, have different shapes in order to accommodate the desired drive components. The carrier body expansion may advantageously form a ring that can be attached to the outside contour of the carrier base body with its inside contour. In this respect, it goes without saying that different carrier body expansions can be attached to the same carrier base body in order to individually adapt the door drive housing to the respective door drive components to be accommodated. The carrier base body preferably contains a peripheral edge or a peripheral web, onto which the carrier body expansion can be attached with its inside contour. When the housing expansion is detached, the non-expanded cover is attached onto the aforementioned web on the edge of the carrier base body.

In order to achieve a stable connection between the housing expansion and the carrier base body, the carrier body expansion is preferably provided with positive connecting means for being mounted on the carrier base body. The positive connecting means preferably comprise a flange that overlaps the edge of the carrier base body and/or tab-shaped mounting lugs for mounting the carrier body expansion on the carrier base body by means of screw bolts. Alternatively, the positive connecting means may also comprise snap-in means for interlocking the carrier body expansion and the carrier base body.

According to one additional development of the invention, the housing expansion itself is realized in a modular fashion. The carrier body expansion may be composed of several parts that can be separably connected to one another and/or to the carrier base body. The various expansion parts can be assembled in different combinations such that carrier body expansions of different sizes and different shapes are obtained.

The expansion parts are preferably provided with first positive connecting means for positively interlocking the individual expansion parts. Flexible snap-in tabs and complementary depressions are preferably provided on the expansion parts. The thusly achieved interlocking not only makes it possible to rapidly assemble the expansion parts, but also ensures a rigid connection between the individual parts. The expansion parts preferably are also provided with second positive connecting means for being positively mounted on the carrier base body. This also ensures a rapid attachment of the individual parts to the carrier base body.

The carrier base body itself may be realized in different ways. It is practical that the carrier base body accommodates at least the drive motor itself, a gear and a control device of the door drive. For this purpose, the carrier base body comprises corresponding receptacle means with mounting flanges that are elevated referred to the plate-shaped base surface and on which the respective drive component can be mounted in a precisely fitted fashion.

The carrier base body preferably contains positive connecting means on one outer side in order to connect the carrier base body to the rail, along which the sled of the door drive can be displaced. This sled is driven by the drive motor accommodated in the housing via a drive chain or a drive belt in order to open or close the door.

The door drive housing may also comprise a plug-type receptacle and corresponding interlocking means for a drive motor/gear unit to be inserted into the housing. It is preferred that the plug-type receptacle for the door drive motor/gear unit essentially has the shape of a circular cylinder. According to a first preferred embodiment, bayonet-like interlocking means are provided in the plug-type receptacle, wherein the door drive motor/gear unit can be engaged with these interlocking means by turning the motor/gear unit in the plug receptacle. Corresponding radial flanges are provided on the drive motor/gear unit for this purpose. These radial flanges can be engaged with the bayonet-like interlocking means in the plug-type receptacle. For this purpose, the drive motor/gear unit is initially inserted into the plug-type receptacle in an essentially perpendicular position and then turned in the plug-type receptacle about the inserting axis such that the radial flanges are engaged with the bayonet-like interlocking means. In order to prevent an unintentional separation of the interlocked components, snap-in means are advantageously provided in order to positively interlock the drive motor/gear unit and the plug-type receptacle when the motor/gear unit is turned, wherein these snap-in means also prevent the drive motor/gear unit from being turned backward and disengaging from the bayonet-like interlocking means. The snap-in means may comprise snap-in tabs that act in the peripheral direction and are able to springably yield in the inserting direction such that the corresponding sections on the drive motor/gear unit are able to slide over the snap-in tabs when the unit is turned in order to interlock the components. In the completely interlocked position, the snap-in tabs spring back and prevent the drive motor/gear unit from being turned backward.

In an alternative embodiment of the invention, the bayonet-like interlocking means are replaced with holding means that are undercut in the inserting direction on one side of the plug-type receptacle, as well as corresponding snap-in means on the opposite side of the plug-type receptacle. In this case, the drive motor/gear unit is initially inserted into the undercut region of the holding means on one side. After pressing the drive motor/gear unit down into the plug-type receptacle, a corresponding section of the drive motor/gear unit is pressed over the snap-in means arranged on the opposite side such that they interlock and the drive motor/gear unit is positively held in the plug-type receptacle, namely by the undercut holding means on one side and the snap-in means on the other side of the plug-type receptacle.

The invention is described in greater detail below with reference to one preferred embodiment and the corresponding figures. The individual figures show:

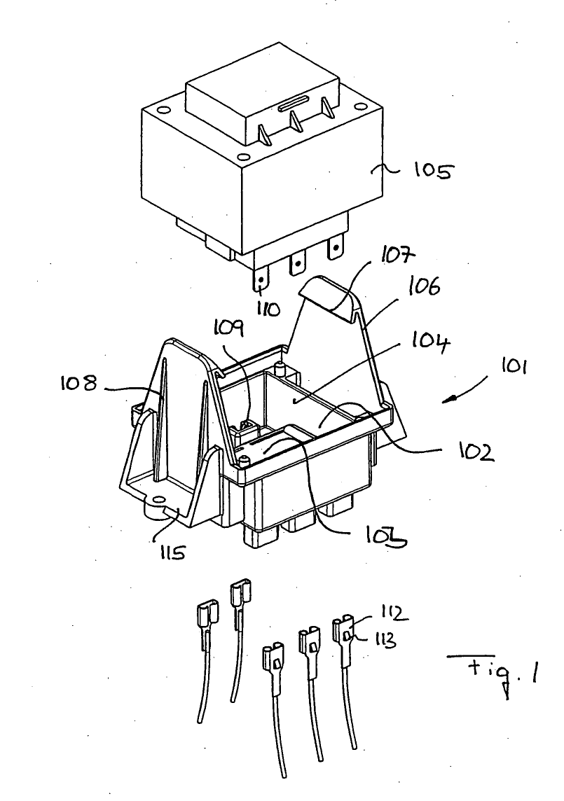

FIG. 1 a perspective representation of a transformer of a door drive, an assembly holding device, into which the transformer needs to be inserted, and the electric cables to be connected thereto in the form of an exploded view;

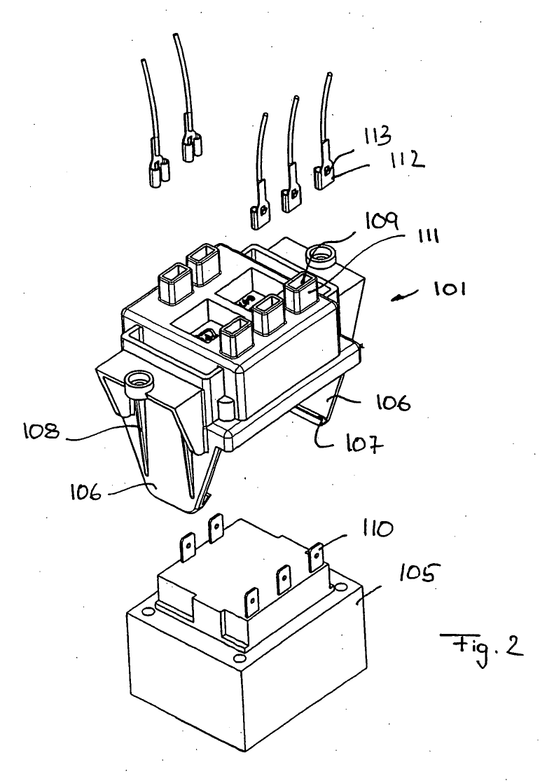

FIG. 2 a schematic exploded view of the bottom of the transformer, the assembly holding device and the electric cables;

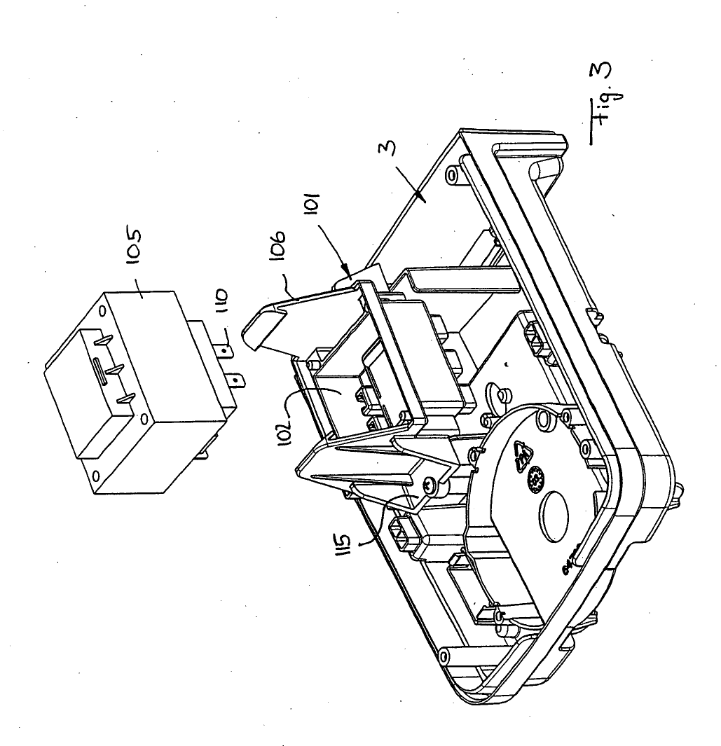

FIG. 3 a perspective representation of the assembly holding device and the transformer to be inserted, wherein the assembly holding device is pre-installed on a carrier base body of the door drive housing;

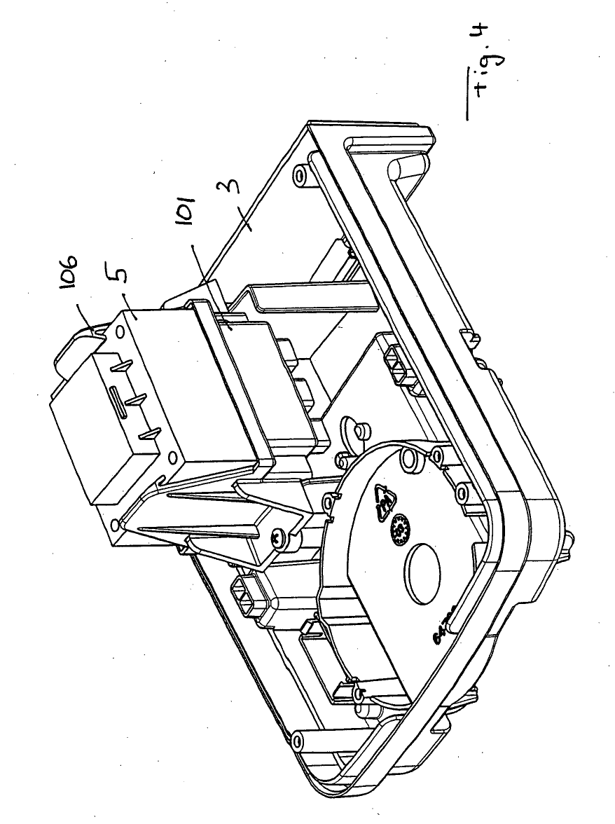

FIG. 4 a perspective representation similar to FIG. 3 of the transformer and the pre-installed assembly holding device, wherein the transformer is inserted into the assembly holding device;

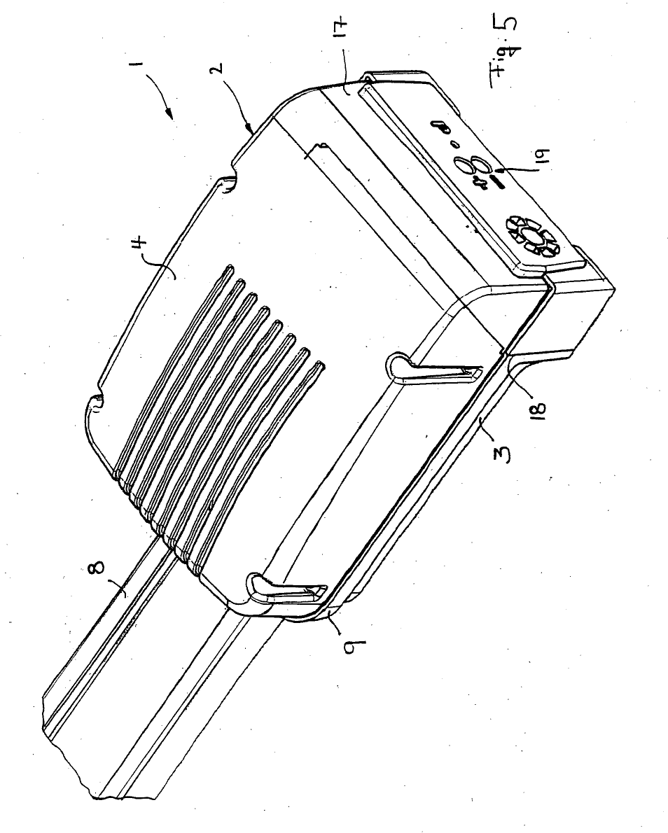

FIG. 5 a perspective representation of the entire door drive housing according to one preferred embodiment of the invention with a carrier base body and a cover attached thereon;

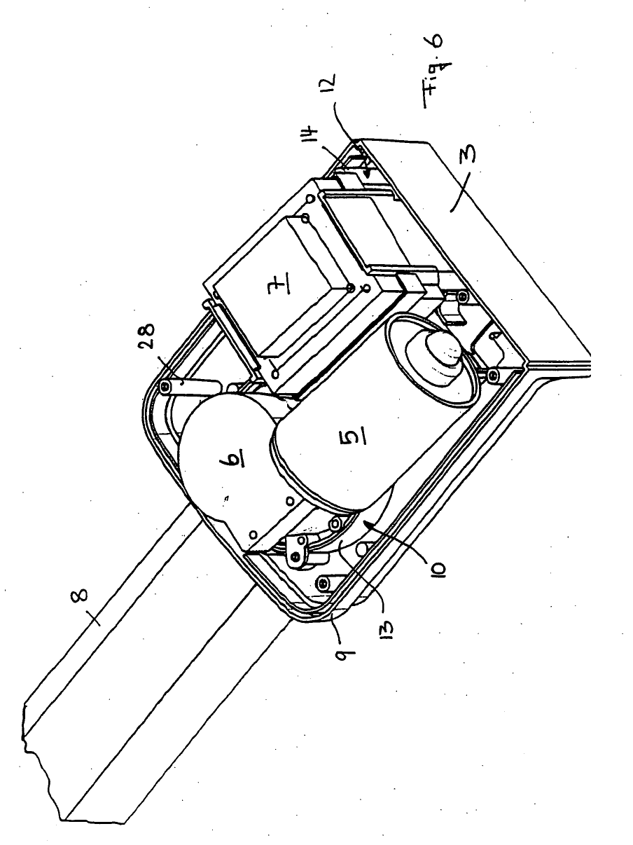

FIG. 6 the door drive housing shown in FIG. 5, wherein the cover is removed such that the drive components held on the carrier base body are visible;

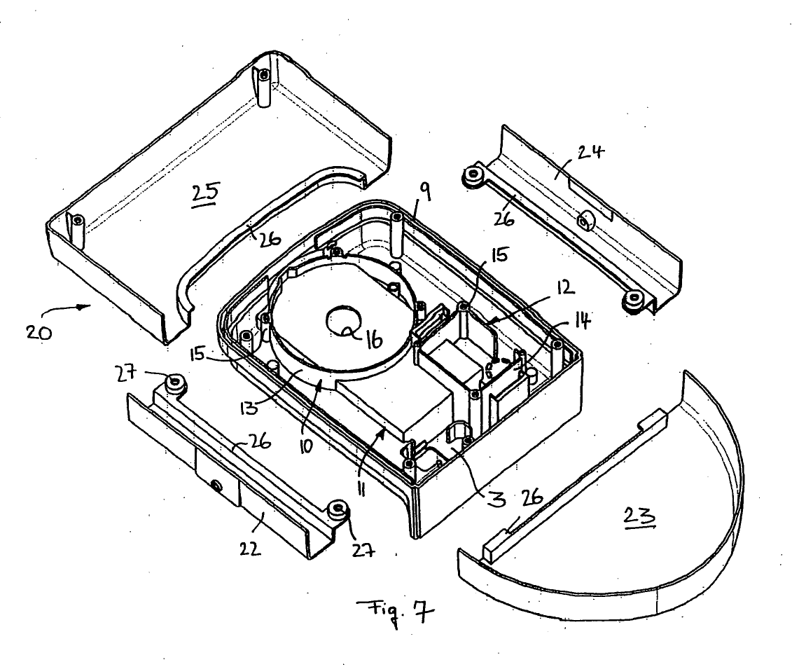

FIG. 7 the carrier base body of the housing shown in the preceding figures, as well as expansion parts of a housing expansion that are not yet attached to the carrier base body;

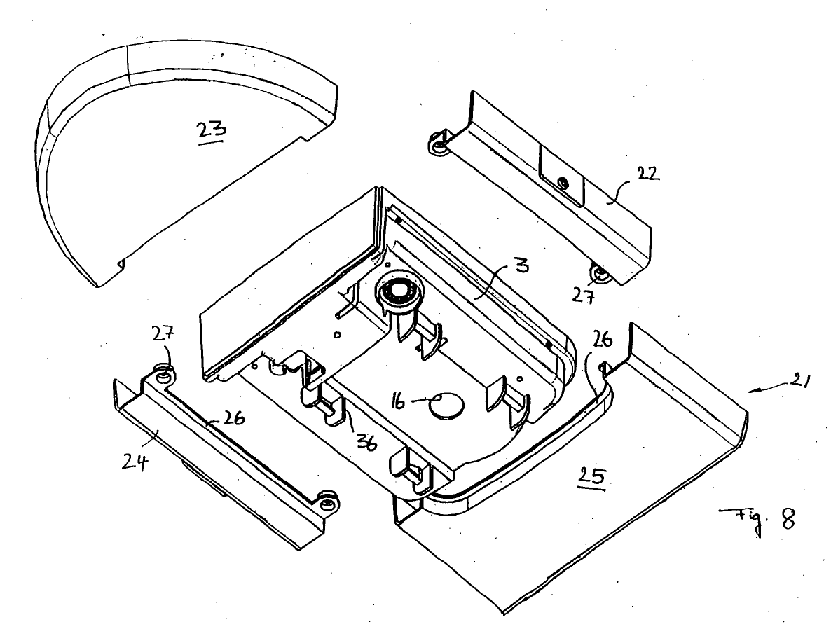

FIG. 8 the outside of the carrier base body with the housing expansion parts in the form of a perspective representation;

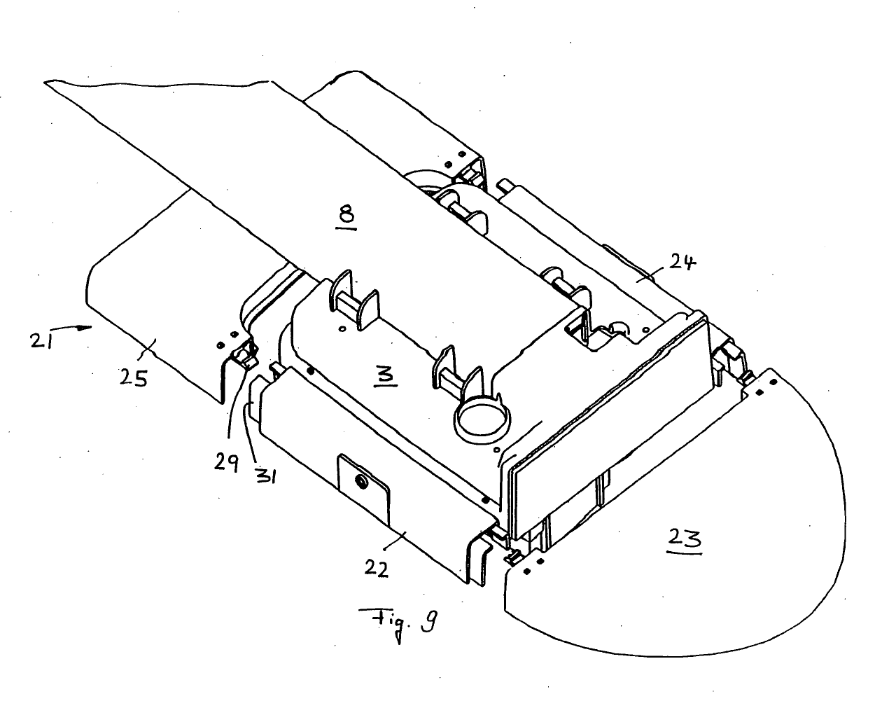

FIG. 9 a perspective representation of the carrier base body from one outer side, wherein a sled rail is connected to the carrier base body, and wherein two side parts of the housing expansion are already mounted on the carrier base body while two other housing expansion parts are not yet mounted thereon;

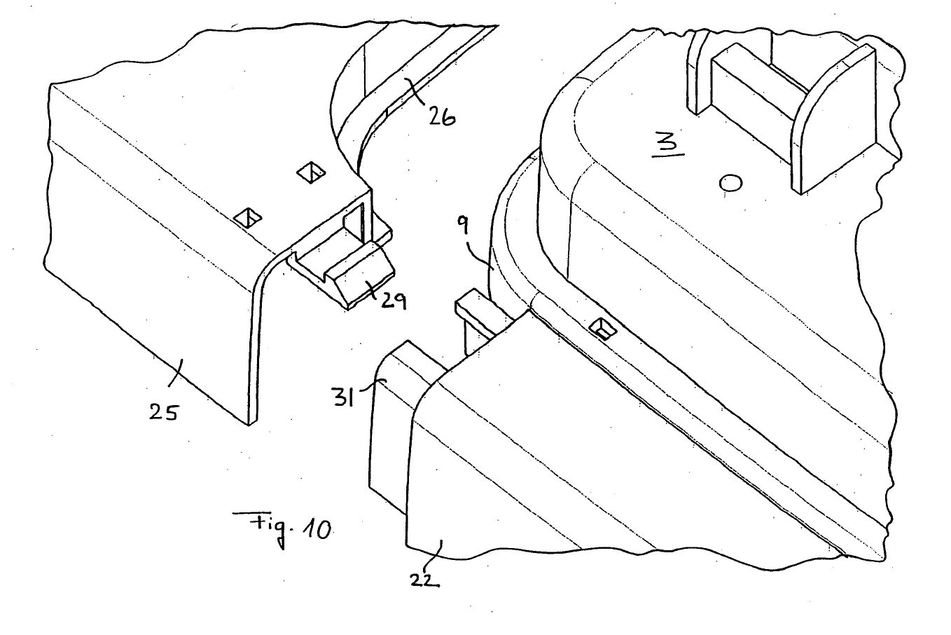

FIG. 10 an enlarged detail of the snap-in connection between two housing expansion parts in the form of a perspective representation from one outer side;

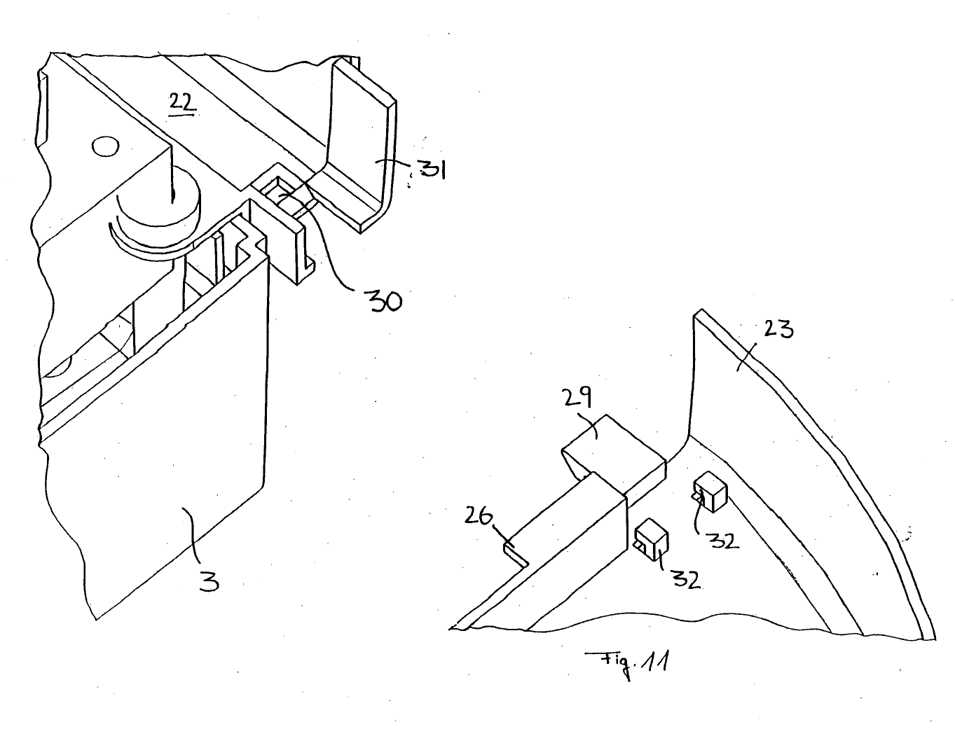

FIG. 11 an enlarged detail of the snap-in connection between the two housing expansion parts shown in FIG. 10, namely in the form of a perspective representation from one inner side of the housing;

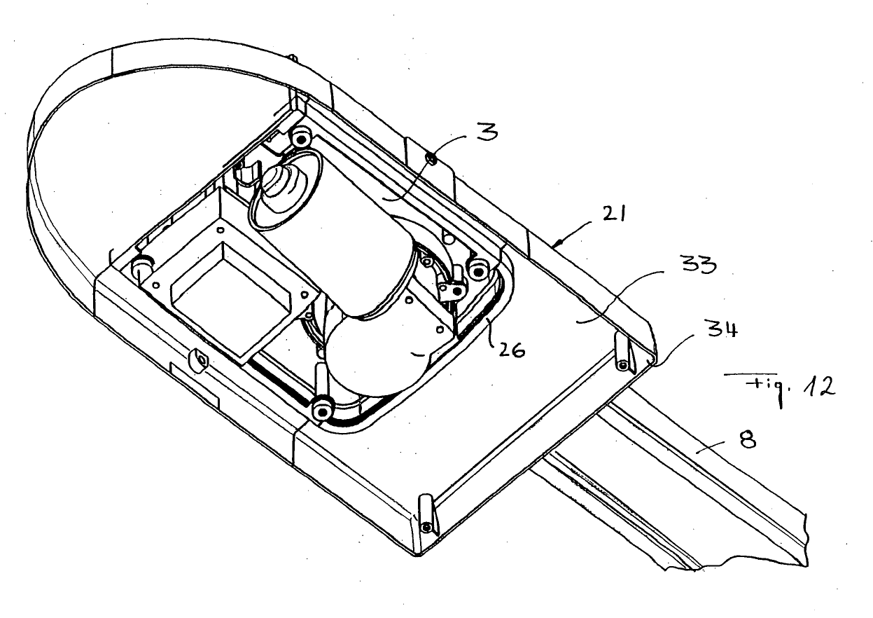

FIG. 12 a perspective top view of the inner side of the expanded carrier shell consisting of the carrier base body and the carrier body expansion mounted thereon;

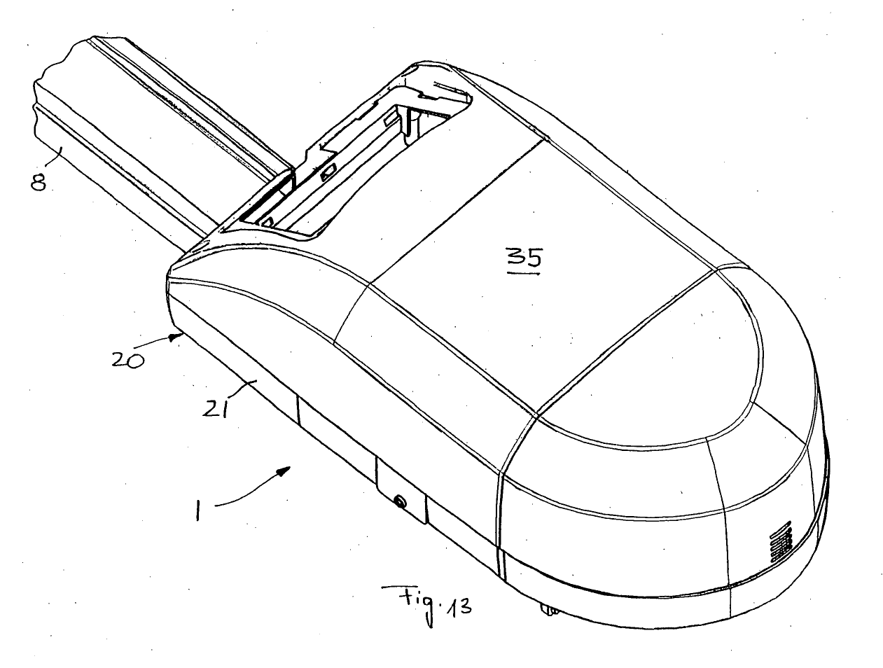

FIG. 13 a perspective representation similar to FIG. 5 of the complete housing including the housing expansion;

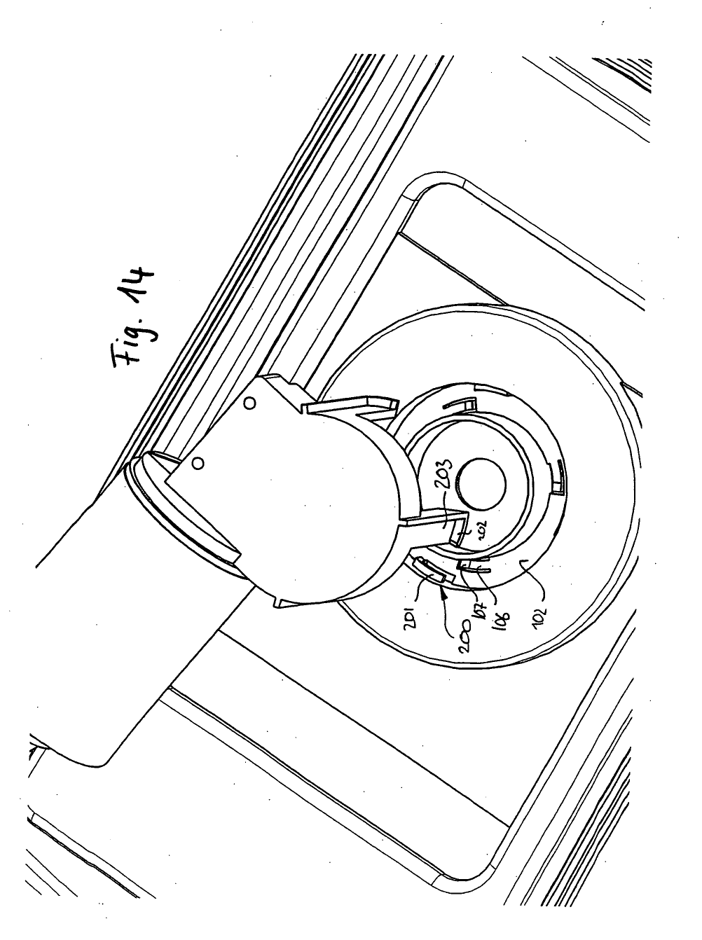

FIG. 14 a schematic perspective representation of a plug-type receptacle for a drive motor/gear unit which comprises bayonet-like interlocking means, as well as snap-in means assigned thereto;

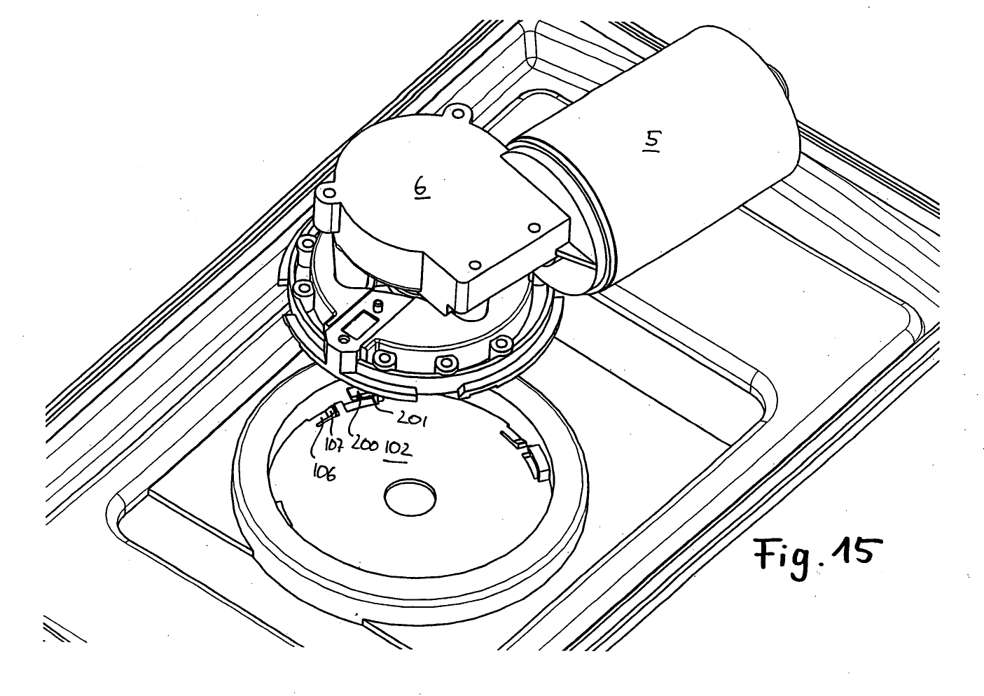

FIG. 15 a schematic perspective representation of a plug-type receptacle for a drive motor/gear unit that is realized similar to FIG. 14 and comprises bayonet-like interlocking means and snap-in means assigned thereto;

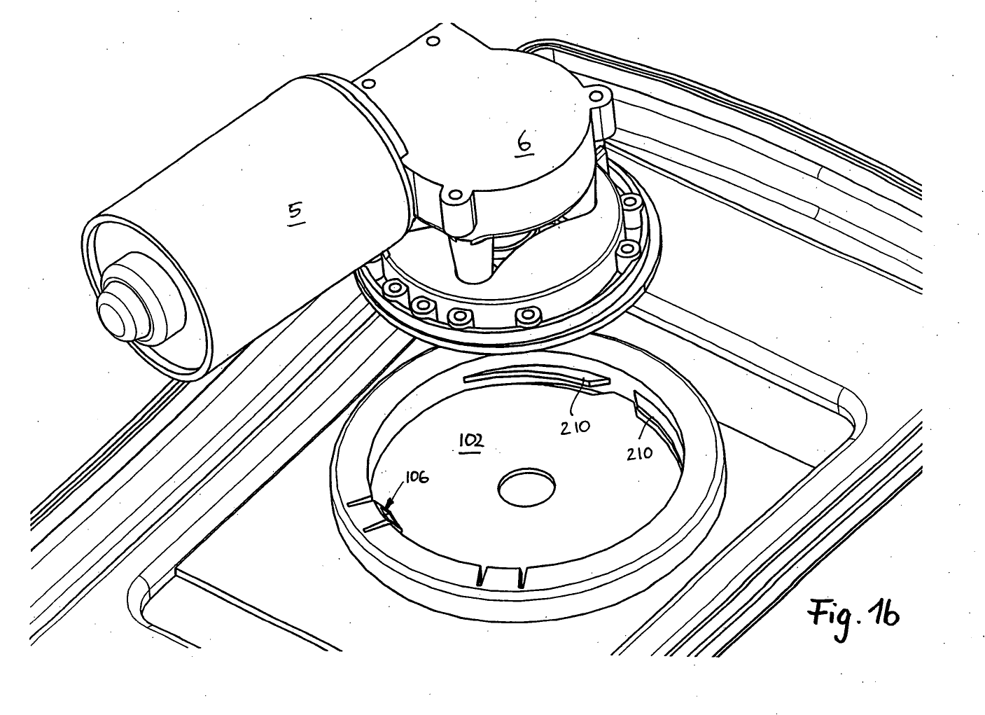

FIG. 16 a schematic perspective representation of a plug-type receptacle for a drive motor/gear unit, in which undercut holding means in the form of radial projections are provided on one side of the plug-type receptacle and snap-in means are provided on the other side of the plug-type receptacle, and

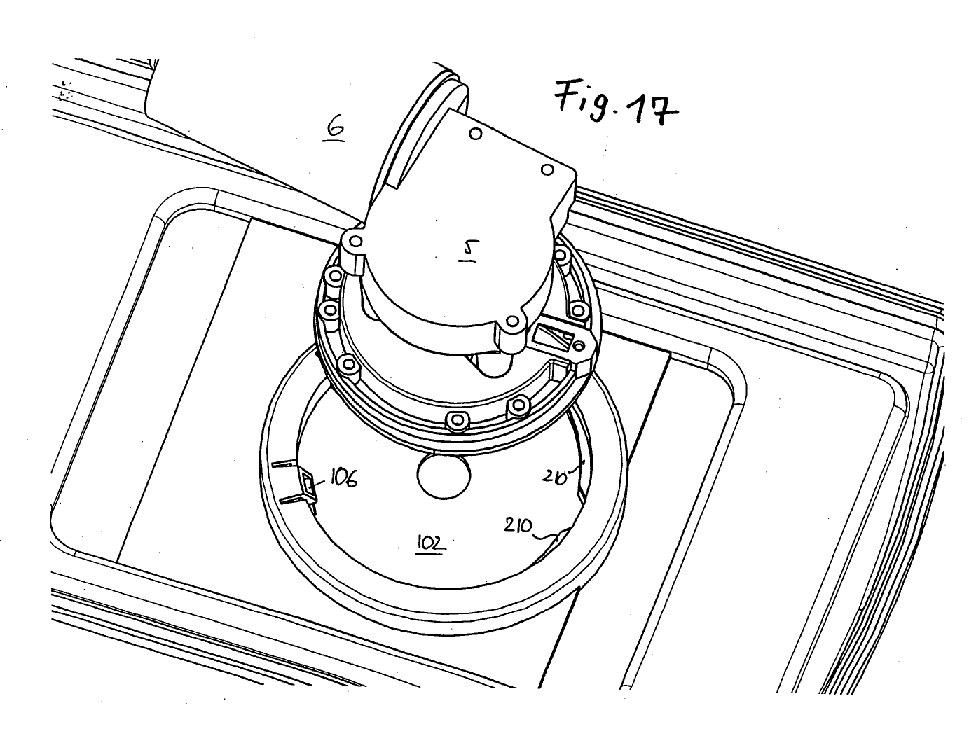

FIG. 17 a perspective representation of the plug-type receptacle shown in FIG. 16 from a different viewing direction, wherein the design of the snap-in means is illustrated in greater detail in this figure.

The assembly holding device 101 shown in FIG. 1 consists of an injection-molded plastic part that has an essentially pot-shaped or trough-shaped geometry. A plug-type receptacle 102 is essentially limited by the bottom 103 and the peripheral wall 104 that is adapted to the outside contour of the electrical assembly to be mounted, namely the transformer 105 in the embodiment shown. The inner sides of the peripheral wall 104 are adapted to the outside contour of the transformer 105 in such a way that the transformer can be inserted into the plug-type receptacle 102 in a precisely fitted fashion, i.e., without essentially any play.

Two snap-in tabs 106 that essentially protrude parallel to the inserting direction defined by the plug-type receptacle 102 are integrally formed onto the plug-type receptacle 102 on opposite sides. In this case, the snap-in tabs 106 are realized in a flange-shaped or web-shaped fashion and carry an inwardly protruding snap-in hook 107 on their free protruding ends. On the outer side, the snap-in tabs 106 are reinforced with reinforcing ribs 108 that extend parallel to the inserting direction, wherein the reinforcing ribs are integrally formed onto the snap-in tabs 106 and tapered toward the free ends, i.e., the reinforcing ribs have a tapered cross section (see FIG. 1).

When the transformer 105 is inserted between the snap-in tabs 106 of the plug-type receptacle 102, the two snap-in tabs 106 are laterally pressed away by the wedge-shaped inclined surfaces of the snap-in hooks 107. The peripheral wall 104 of the plug-type receptacle 102 centers and exactly positions the transformer 105 during the insertion. Once the transformer 105 reaches its completely inserted position, the snap-in tabs 106 spring back and positively interlock with the corresponding contour of the transformer 105.

Several through-openings 109 are arranged in the bottom 103 of the assembly holding device 101. The positions of these through-openings corresponds to those of the electric terminals 110 arranged on the end face of the transformer 105 to be inserted into the plug-type receptacle 102. According to FIG. 2, the through-openings 109 are limited in the peripheral direction by chimney-shaped projections that are integrally formed onto the bottom 103 of the assembly holding device 101 and protrude from the side of the bottom 103 that is situated opposite of the plug-type receptacle 102. In this case, the through-openings 109 and the projections 111 are realized in the form of plug connector receptacles. The inside contour of the projections 111 is designed for accommodating and holding plug connectors 112 to be attached to the terminals 110 of the transformer 105. The plug connectors 112 may be held in a clamped and/or positive fashion in the plug connector receptacles of the projections 111. FIG. 2 shows that the plug connectors 112 comprise a springable, protruding snap-in tab 113 that serves for interlocking the plug connectors in corresponding recesses in the inside contour of the projections 111.

The installation may be carried out as described below:

The electric lines with the plug connectors 112 are initially inserted into the assembly holding device 101 from the bottom, i.e., the plug connectors are pushed into the plug connector receptacles formed by the projections 111. The thusly prepared assembly holding device 101 is then pre-installed on the housing body 103. For this purpose, the assembly holding device 101 is provided with connecting sections 114 in the form of connecting flanges that laterally protrude from the plug-type receptacle 102 and can be connected to corresponding mounting sections of the housing body 3 by means of screws.

The transformer 105 is then simply inserted into the thusly prepared door drive housing, namely into the plug-type receptacle 102 of the assembly holding device 101. During this process, the plug-type receptacle 102 centers the transformer 105 such that the terminals 110 are automatically threaded into the plug connector receptacles of the projections 111 and the plug connectors 112 accommodated therein. Once the transformer 105 is completely pressed against the bottom of the plug-type receptacle 102, the snap-in tabs 106 spring back and engaged such that the transformer 105 is reliably locked in its holding device.

The entire door drive housing is realized in a modular fashion. In addition to the assembly holding device 101, it is possible to connect other components to the housing body, wherein the housing body can also be expanded as described in greater detail below with reference to FIGS. 5-14.

The door drive 1 according to FIGS. 5 and 6 comprises a door drive housing 2 that is composed of a carrier base body 3 and a cover 4 attached thereon. According to FIG. 6, a drive motor 5, a gear 6 and an electronic control device 7 are arranged on the carrier base body 3 in the interior of the door drive housing 2. The door drive housing 2 is seated on a sled rail 8 in which a belt or, if applicable, a chain driven by the drive motor 5 via the gear 6 can be displaced in order to drive a sled supported on the sled rail 8.

According to FIG. 7, the carrier base body 3 is—in essence—realized in an approximately plate-shaped fashion, wherein a peripheral web 9 is provided on the edge. A groove is recessed into this web along three sides of the carrier base body 3 such that a double wall is formed. The cover 4 can be attached onto the web 9 and inserted into the groove recessed therein in a precisely fitted fashion. On its inner side, the carrier base body 3 comprises first, second and third receptacles 10, 11 and 12 that respectively serve for mounting the drive motor 5, the gear 6 and the control device 7. In this case, the receptacles 10, 11 and 12 respectively comprise inwardly protruding, elevated mounting flanges, onto which the corresponding drive components can be attached. Mounting lugs 15 are integrally formed onto the flanges 13, 14 and serve for accommodating screw bolts for mounting the respective components. In the region of the gear receptacle 10, the carrier base body 3 comprises a circular drive shaft opening 16, through which the drive shaft of the drive extends in order to drive the chain or the belt that can be displaced in the sled rail 8.

According to FIG. 14, a plug-type receptacle 102 may also be provided for a drive motor/gear unit 5, 6. FIG. 14 shows that this plug-type receptacle is advantageously realized with a circular or rotationally symmetrical cross section, respectively. Bayonet-like interlocking means 200 consisting of radial webs or flanges 201 are provided on the bottom of the plug-type receptacle 102, wherein these interlocking means are arranged in such a way that gap-like recesses are limited between the interlocking means and the bottom of the plug-type receptacle 102 (see FIG. 14). The bayonet-like interlocking means 200 are arranged on the outer edge of the bottom of the plug-type receptacle 102. Complementary interlocking sections of the drive motor/gear unit 5, 6 can be engaged with the bayonet-like interlocking means 200. According to FIG. 14, interlocking sections 202 are provided for this purpose, wherein the interlocking sections consist of radial flanges or webs arranged on fingers 203 that protrude in the inserting direction.

In order to interlock the drive motor/gear unit 5, 6 and the door drive housing, the gear 6 is perpendicularly inserted into the plug-type receptacle 102. Once the fingers 203 come in contact with the bottom of the plug-type receptacle 102, the drive motor/gear unit 5, 6 is turned about the inserting axis such that the interlocking sections 202 are positively engaged with the bayonet-like interlocking means 200 in the plug-type receptacle 102.

In order to prevent an unintentional automatic separation of the bayonet-like interlocking means 200, snap-in means 106 are assigned to the interlocking means. In the embodiment shown, the snap-in means 106 are arranged on the bottom of the plug-type receptacle 102 and act in the peripheral direction. These snap-in means consist of snap-in tabs that extend in the peripheral direction and comprise a snap-in hook 107 that protrudes upward into the plug-type receptacle 102. When the fingers 203 of the gear 6 come in contact with the bottom of the plug-type receptacle 102, the end faces of the fingers 203 initially cause the snap-in tabs 106 to yield elastically. During the turning motion into the bayonet-like interlocking means 200, the end faces of the fingers 203 slide over the snap-in hooks 107. Once the interlocked position is reached, the snap-in hooks 107 spring back and engage with corresponding sections of the fingers 203 such that the drive motor/gear unit 5, 6 is secured in the plug-type receptacle 102.

FIG. 15 shows a basically similar plug-type receptacle 102 for the drive motor/gear unit 5, 6. Bayonet-like interlocking means 200 in the form of radial webs 201 are also arranged on the bottom of the rotationally symmetrical plug-type receptacle 102 in this case, wherein snap-in means 106 are analogously provided on the bottom of the plug-type receptacle 102. As in the embodiment according to FIG. 14, the snap-in means 106 form a turning safety that prevents the drive motor/gear unit 5, 6 from turning out of the bayonet-like interlocking means 200. If so required, it would also be conceivable to arrange the snap-in means on the periphery of the plug-type receptacle 102 rather than on the bottom. This also applies to the bayonet-like interlocking means. However, it is preferred to utilize the arrangement on the bottom shown in FIGS. 14 and 15.

According to FIGS. 16 and 17, the plug-type receptacle 102 for the drive motor/gear unit 5, 6 may also be provided with a snap-in interlocking means instead of the bayonet-like interlocking means. FIG. 16 shows that an undercut holding means 210 in the form of radial projections may be provided on one side. The drive motor/gear unit can initially be inserted into the plug-type receptacle 102 underneath the holding means 210 that protrude radially inward. Once the opposite side of the section of the gear 6 to be inserted into the plug-type receptacle 102 is pressed into the plug-type receptacle 102, the aforementioned opposite section is positively interlocked by the snap-in means 106. According to FIG. 17, the snap-in means 106 consist of snap-in tabs that protrude radially inward on the side situated opposite of the holding means 210 and can be bent radially outward in a springable fashion. For this purpose, the snap-in tabs 106 are realized in a wedge-shaped fashion such that the section of the gear 6 to be inserted into the plug-type receptacle 102 is able to slide over and press away the snap-in tabs. Once the drive motor/gear unit 5, 6 is completely inserted into the plug-type receptacle 102, the snap-in tabs 106 spring back radially inward such that the snap-in tabs 106 positively hold the drive motor/gear unit in the plug-type receptacle 102 together with the holding means 210.

In order to prevent the drive motor/gear unit from turning, a turning safety is provided in the plug-type receptacle 102. This turning safety consists of a radial lug 211 provided on the gear 6, as well as a radial recesses that is realized in the form of an interruption of the two holding webs 210 in the embodiment shown.

The cover 4 shown in FIG. 5 contains an overhang 17 on one end face, wherein said overhang encompasses the carrier base body 3. The edge contour 18 of the cover 4 that is seated on the web 9 on the edge of the carrier base body 3 has a stepped, about perpendicularly bent progression at the transition to the overhang 17 such that the connection between the cover 4 and the carrier base body 3 is not produced in a single plane, but rather along surfaces the are angled relative to one another. This makes it possible to achieve an improved stability.

Operating interfaces 19, e.g., connections or radio transmitters/receivers for operating the control unit 7, may be provided on the end face of the overhang 17.

In order to accommodate other drive components, e.g., a light barrier device, additional control components, etc., in the door drive housing 2, a housing expansion 20 can be connected to the carrier base body 3 so as to expand the interior of the door drive housing 2. FIG. 7 shows that the housing expansion 20 comprises a carrier body expansion 21 that is composed of four expansion parts 22, 23, 24 and 25. Each of the expansion parts 22-25 can be respectively attached to one of the four sides of the carrier base body 3 in a precisely fitted fashion. In this respect, it goes without saying that the carrier body expansion 21 may also be divided into more or less than four parts. In the essentially rectangular embodiment of the carrier base body 3 shown in the figures, it is advantageous that the carrier body expansion 21 is composed of four parts.

In this case, the carrier body expansion 21 comprises two identical side parts 22 and 24 and two differently designed face parts 23 and 25. The expansion parts 22-25 form a ring, the inside contour of which corresponds to the outside contour of the carrier base body 3. The inside contour of the annular carrier body expansion 21 consisting of the expansion parts 22-25 comprises an angled mounting flange 26, by means of which the inside contour of the carrier body expansion 21 overlaps the web 9 on the edge of the carrier base body 3 and adjoins the carrier base body 3 in a precisely fitted fashion. The expansion parts 22-25 can be connected to one another and to the carrier base body 3.

According to FIG. 9, the opposite side parts 22 and 24 are initially attached to the carrier base body 3. On their mounting flange 26, the aforementioned side parts 22 and 24 contain integral mounting lugs 27 for inserting screw bolts that serve for screwing the side parts 22 and 24 to the carrier base body 3. FIG. 3 shows that the carrier base body 3 is provided with screw receptacles 28, on which the mounting lugs 27 lie and into which the corresponding screws can be screwed.

The face parts 23 and 25 are interlocked with the side parts 22 and 24. According to FIGS. 10 and 11, axially protruding snap-in tabs 29 are integrally formed onto the respective face parts 23 and 25, and the side parts 22 and 24 are provided with complementary recesses 30 on their inner sides. The snap-in tabs 29 are able to engage into these recesses when the axially protruding snap-in tabs 29 are pushed over the side parts 22 and 24 and initially subjected to an elastic deformation. Axially protruding overlap sections 31 that are pushed over the inside contour of the face parts 23 and 24 in a precisely fitted fashion are integrally formed onto the side parts 22 and 24 in order to additionally stabilized the connection. The face parts 23 and 25 are provided with additional receptacle claws 32, into which the overlap sections 31 can be inserted such that they are overlapped by the receptacle claws 32. The overlap sections 31 preferably have a bent contour that corresponds to the bent contour of the web on the edge of the face parts. This makes it possible to improve the stability of the connection.

According to FIG. 11, the snap-in tabs 29 and the overlap sections 31 engage into one another in a fork-shaped fashion and respectively overlap the adjacent section of the side part or face part, respectively.

The design of the mounting flanges 21 on the face parts that flatly adjoin the edge contour of the carrier base body 3 in two planes that are angled for relative to one another results in an additional reinforcement of the connection between the face parts 23 and 25 and the side parts 22 and 24.

FIG. 12 shows that the carrier body expansion 21 and the carrier base body 3 form an expanded carrier shell 33 with more space for accommodating additional drive components. The edge of the expanded carrier shell 33 contains a peripheral web 34 that is composed of the corresponding webs on the edges of the expansion parts 22-25. The peripheral web 34 of the expanded carrier shell 33 is elevated relative to the web 9 on the edge of the carrier base body 3.

A larger cover 35 can now be attached onto the expanded carrier shell 33, wherein this cover is preferably seated on the web 34 along the edge as shown in FIG. 9. If so required, the cover 35 may be composed of several cover parts such that different housing sections can also be individually opened.

The housing parts may, in principle, be manufactured of sheet metal. However, it is preferred to utilize injection molded plastic parts.

FIGS. 8 and 9 elucidate that the underside of the carrier base body 3 is provided with connecting means 36 for being connected to the sled rail 8 in a precisely fitted fashion, wherein the connecting means 36 in the embodiment shown comprise a depression that corresponds to the contour of the sled rail 8, as well as laterally protruding mounting webs.

The holding device 101 for the electrical assembly can be mounted on the housing body in the same fashion as the control device and was omitted in FIGS. 5-13 in order to provide a better overview.

1. A door housing with an assembly holding device (101) for mounting an electric door drive assembly (105) with at least one electric terminal (110), particularly of a transformer, wherein the assembly holding device (101) contains preferably separable mounting means (106) for mounting the assembly (105), wherein the mounting means (106) contain a plug-type receptacle (102), into which the assembly (105) can be inserted, as well as snap-in means (106) that positively interlock with the assembly (105) during the insertion into the plug-type receptacle (102).

2. The drive door housing according to claim 1, wherein at least one through-opening (109) is arranged in the bottom (103) of the plug-type receptacle (102), and wherein said through-opening serves for accommodating the electric terminal (110) and forms a plug connector receptacle for a plug (112) to be connected to the terminal (110).

3. The drive door housing according to claim 2, wherein the plug connector receptacle is realized in the form of a chimney-shaped projection (111) that is integrally formed onto the bottom (103) of the plug-type receptacle (102) and annularly encompasses the electric terminal (110) of the inserted assembly (101).

4. The door drive housing according to claim 1, wherein the snap-in means (106) comprise two flange-shaped, elastic snap-in tabs (106) that extend essentially parallel to the inserting direction defined by the plug-type receptacle (102) and are realized in such a way that they laterally yield in an elastic fashion during the insertion of the assembly (101) and spring back and interlock with the inserted assembly (101) once the mounting position is reached.

5. The door drive housing according to claim 1, wherein the snap-in tabs (106) are integrally formed onto the plug-type receptacle (102) and preferably form extensions of opposite plug-type receptacle walls, namely in the form of projections.

6. The door drive housing according to claim 4, wherein the snap-in tabs (106) are provided with reinforcing ribs (108), the cross section of which preferably increases in the inserting direction.

7. The drive door housing according to claim 5, wherein the plug-type receptacle (102) has a cross section that, referred to the inserting axis, deviates from a circular shape and prevents the assembly to be inserted from being turned about the inserting axis.

8. The door drive housing according to claim 1, wherein the plug-type receptacle (102) has a circular cross section such that the assembly can be turned in the plug-type receptacle (102), wherein bayonet-like interlocking means (200) for being interlocked with the assembly by a turning motion are provided in the plug-type receptacle, and wherein the snap-in means (106) are realized in such a way that they positively interlock with the assembly when the assembly is turned into the interlocking means (200).

9. The door drive housing according to claim 1, wherein one side of the plug-type receptacle (102) is provided with holding means (210) that are undercut in the inserting direction, and wherein the snap-in means (106) are arranged in the plug-type receptacle (102) on the opposite side.

10. The door drive housing according to claim 1, wherein the assembly (105) consists of a transformer.

11. The door drive housing according to claim 1, wherein the assembly consists of a drive motor/gear unit (5, 6).

12. The door drive housing according to claim 1, wherein the assembly holding device (101) contains connecting means (115) for being connected to a housing body of the door drive housing.

13. The door drive housing according to claim 1, wherein the housing has a modular design and is composed of several housing parts and assembly carriers.

14. The door drive housing according to claim 1, wherein a preferably shell-shaped carrier base body (3), on which the various drive components (5, 6, 7) can be mounted, and a cover (4, 35) that can be connected to the carrier base body (3) are provided, and wherein a housing expansion (20) for accommodating additional and/or larger drive components can be separately connected to the carrier base body (3) in a precisely fitted fashion.

15. The door drive housing according to claim, wherein the housing expansion (20) consists of a carrier body expansion (21) that can be separably connected to the carrier base body (3) and contains a cover (35) that can be connected to at least the carrier body expansion (21).

16. The door drive housing according to claim, wherein the cover (35) of the housing expansion (20) extends over the carrier base body (3), as well as the carrier body expansion (21) connected thereto, and limits a common housing interior.

17. The door drive housing according to claim 10, wherein the cover (35) of the housing expansion (20) adjoins the cover (4) seated on the carrier base body (3) in a precisely-fitted fashion and only covers the carrier body expansion (21) connected to the carrier base body (3).

18. The door drive housing according to claim 15, wherein the carrier body expansion (21) has a connecting contour (26) that can be seamlessly connected to an outside contour (9) of the carrier base body (3) and forms an expanded carrier shell (33) together with the carrier base body (3), and wherein said carrier shell preferably contains a peripheral web (34) along its edge, onto which the cover (35) of the housing expansion (20) can be attached.

19. The door drive housing according to claim 15, wherein the carrier body expansion (21) forms a ring that can be attached to the outside contour (9) of the carrier base body (3) with its inside contour.

20. The door drive according to claim 15, wherein the carrier body expansion (21) contains positive connecting means (27) for being mounted on the carrier base body (3).

21. The door drive according to claim 15, wherein the carrier body expansion (21) is composed of several parts (22, 23, 24, 25) that can be separately connected to one another and/or to the carrier base body (3).

22. The door drive housing according claim, wherein the parts (22, 23, 24, 25) contain first positive connecting means (29, 30) for being positively connected to one another, preferably flexible snap-in tabs (29) and complementary recesses (30) that can be interlocked with one another, as well as second positive connecting means (27) for being positively mounted on the carrier base body (3).

23. The door drive according to claim 15, wherein the inside contour of the carrier body expansion (21) contains a mounting flange (26) that preferably is bent perpendicularly and overlaps the edge of the carrier base body (3).

24. The door drive housing according to claim 1, wherein the carrier base body (3) contains first receptacle means (11) for a drive motor (5), second receptacle means (10) for a gear (6), third receptacle means (12) for a control drive (7) and fourth receptacle means for an electrical assembly carrier (101), and wherein the receptacle means (10, 11, 12) preferably contain elevated mounting flanges (13, 14), onto which the respective drive components can be attached in a precisely fitted fashion.

25. The door drive housing according to claim 1, wherein one outer side of the carrier base body (3) is provided with preferably positive connecting means (36) for being connected to a sled rail (8), on which a door drive slid that is driven via a drive chain or a drive belt is supported such that it can be axially displaced.
